(19) United States
(12) Patent Application Publication
(10) Pub. No.: US 2012/0049716 A1
(43) Pub. Date: Mar. 1, 2012

(54) ILLUMINATION LAMP

(75) Inventors: Chien-Yuan CHEN, Taipei City (TW); Ying-Te CHUANG, Kaohsiung City (TW)

(73) Assignee: POWER DIGITAL DELIGHT CO., LTD., TAIPEI COUNTY (TW)

(21) Appl. No.: 12/872,248

(22) Filed: Aug. 31, 2010

(51) Int. Cl. H01J 61/52

(52) U.S. Cl. 313/46

(57) ABSTRACT

An illumination lamp includes an electric connection portion, a heat dissipating casing, a printed circuit board, light emitting diodes and a transparent cover. The heat dissipating casing is installed onto the electric connection portion and includes abuse wall and a surrounding wall. The base wall has an arc camber protruded from the periphery of the base wall towards the center of the base wall and away from the electric connection portion. The surrounding wall is extended from the periphery of the base wall. The printed circuit board includes a center hole and a groove, and is attached onto the base wall. The light emitting diodes are installed separately on the printed circuit board. The transparent cover is covered onto a side of the heat dissipating casing. Since the light emitting diodes are installed along the arc camber, the illumination range is expanded, and the illumination uniformity is enhanced.

### BACKGROUND OF THE INVENTION

1. Field of the Invention

The present invention relates to an illumination lamp, and more particularly to an illumination lamp capable of expanding the illumination range and enhancing the illumination uniformity of the lamp.

2. Description of the Related Art

In general, a conventional tungsten light bulb has a lamp base with a simple structure, not only providing convenient installations and replacements, but also providing applications for different occasions such as the illumination for corridors, toilets or factories. However, the conventional light bulb has the drawbacks of high power consumption and short lifespan, and even generating high heat after a long time of use, and causing accidents easily during its replacement.

As light emitting diode (LED) technology advances and becomes mature in recent years, an LED light bulb has the advantages of long lifespan, small volume, and quick response, and thus the LED light bulb gradually replaces the conventional tungsten light bulb and becomes a mainstream market in the future.

With reference to FIGS. 1 and 2 for a perspective view and a light path of a conventional LED bulb respectively, the LED bulb comprises an electric connection portion 11, a casing 12, a plurality of light emitting diodes 13 and a lamp cover 14. Since the light emitting diodes 13 are installed on a planar surface of the casing 12, therefore the lights can only be projected from the light emitting diodes 13 at a limited angle and concentrated in a specific area, and the LED bulb fails to provide a uniform illumination and restricts its applicability.

### SUMMARY OF THE INVENTION

It is a primary objective of the invention to provide an illumination lamp capable of expanding the illumination range and improving the illumination uniformity of the lamp.

To achieve the foregoing objectives, the present invention provides an illumination lamp comprising an electric connection portion, a heat dissipating casing, a printed circuit board, a plurality of light emitting diodes and a transparent cover. The heat dissipating casing is installed onto the electric connection portion and includes a base wall and a surrounding wall. The base wall has an arc camber protruded in a direction from the periphery of the base wall towards the center of the base wall and away from the electric connection portion. The surrounding wall is extended outwardly from the periphery of the base wall. The printed circuit board includes a center hole and a groove, and the printed circuit board is attached onto a side of the base wall. The light emitting diodes are installed with an interval apart from each other and on the printed circuit board. The transparent cover is covered onto a side of the heat dissipating casing.

The surrounding wall includes a plurality of heat dissipating ribs.

The electric connection portion further includes a plurality of positioning pillars, and the base wall further includes a plurality of positioning holes, and the positioning pillars correspond to the positioning holes respectively.

The heat dissipating casing is made of aluminum or aluminum alloy.

### BRIEF DESCRIPTION OF THE DRAWINGS

FIG. 1 is a perspective view of a conventional LED bulb;

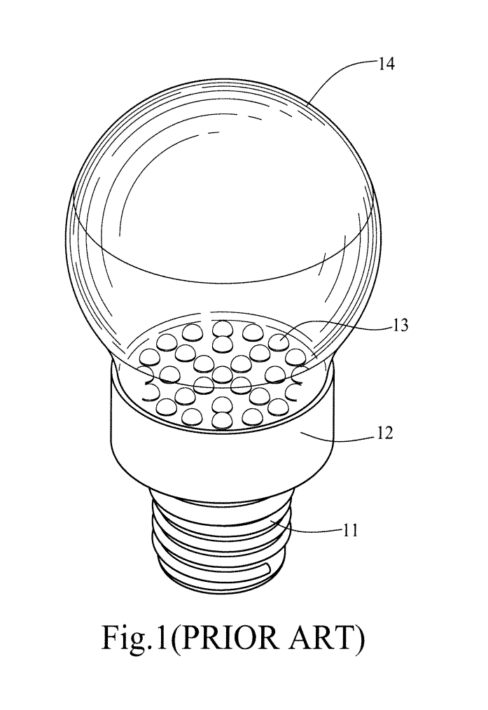

FIG. 2 is a schematic view showing a light path of a conventional LED bulb;

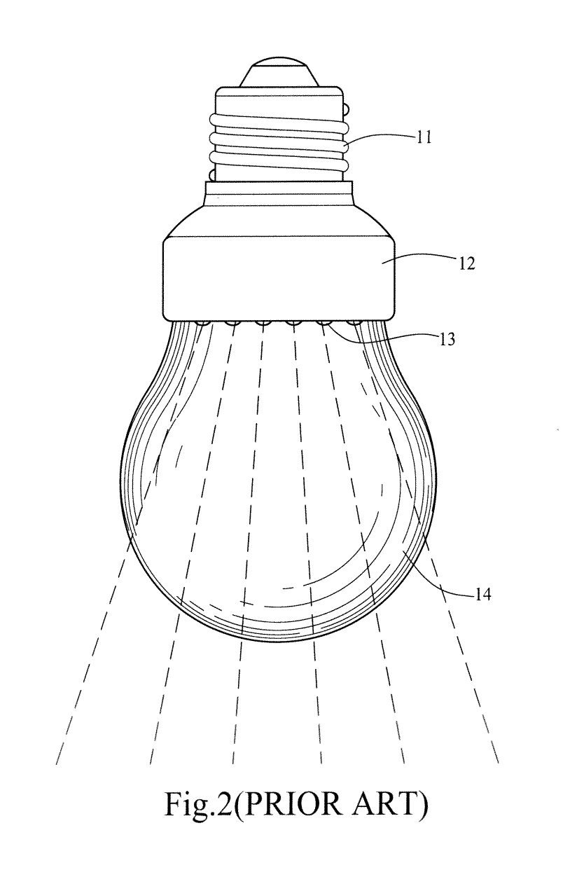

FIG. 3 is an exploded view in accordance with a preferred embodiment of the present invention;

FIG. 4 is a perspective view in accordance with a preferred embodiment of the present invention;

FIG. 5 is a schematic view showing a light path of an illumination lamp in accordance with a preferred embodiment of the present invention;

FIG. 6 is a first schematic view showing an illumination lamp having a thermal conductor installed on a base wall of a heat dissipating casing in accordance with a preferred embodiment of the present invention; and

FIG. 7 is a second schematic view showing an illumination lamp having a thermal conductor installed on a base wall of a heat dissipating casing in accordance with a preferred embodiment of the present invention.

### DETAILED DESCRIPTION OF THE PREFERRED EMBODIMENTS

To make it easier for our examiner to understand the technical contents of the present invention, preferred embodiments together with related drawings are used for the detailed description of the present invention as follows.

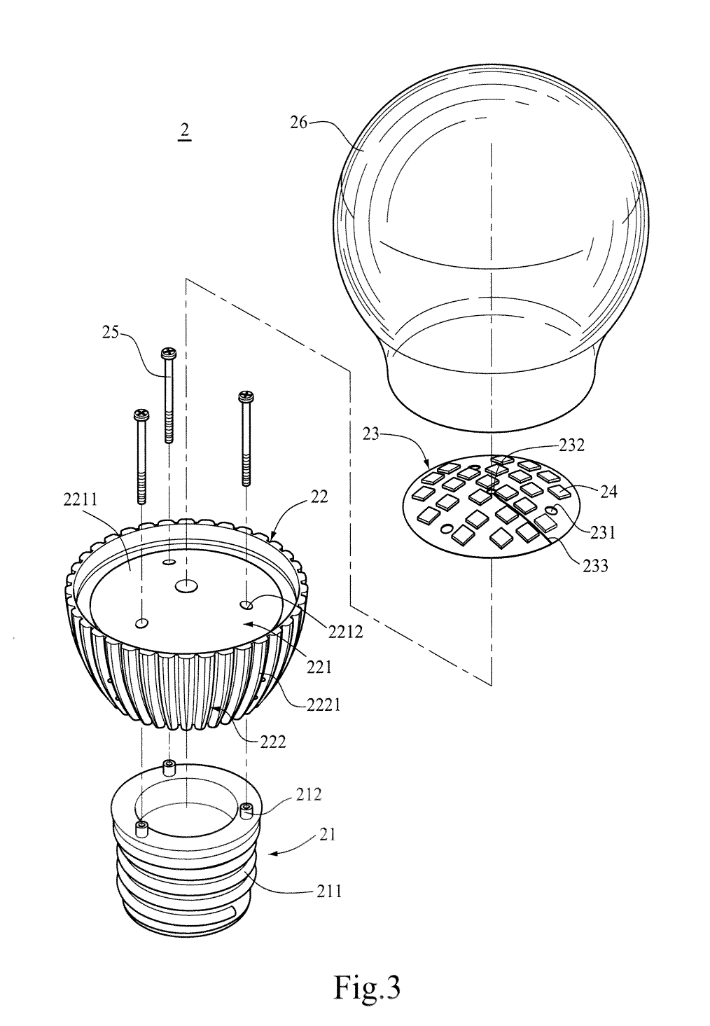

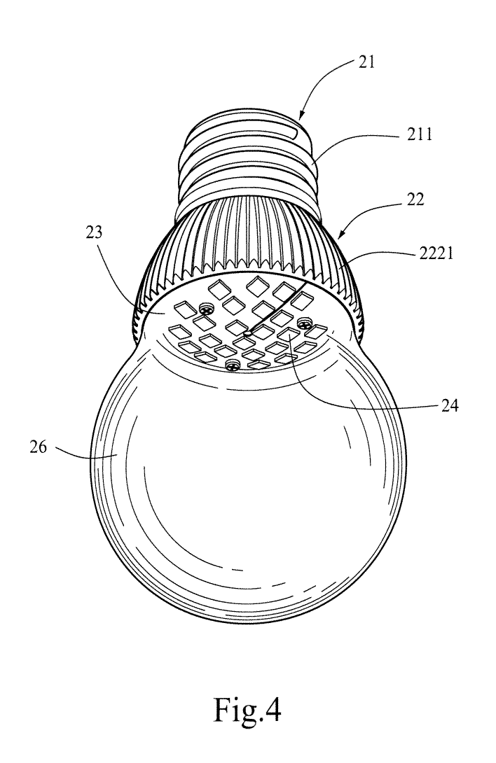

With reference to FIGS. 3 and 4 for an exploded view and a perspective view of and illumination lamp in accordance with a preferred embodiment of the present invention respectively, the illumination lamp 2 comprises an electric connection portion 21, a heat dissipating casing 22, a printed circuit board 23, a plurality of light emitting diodes 24 and a transparent cover 26.

The electric connection portion 21 has a thread 211 and a plurality of positioning pillars 212. The electric connection portion 21 is secured onto a lamp base (not shown in the figure) by the thread 211. The heat dissipating casing 22 can be made of aluminum or aluminum alloy and installed on a side of the electric connection portion 21.

The heat dissipating casing 2 includes a base wall 221 and a surrounding wall 222. The base wall 221 has an arc camber 2211 and a plurality of positioning holes 2212. The arc camber 2211 is protruded in a direction from the periphery of the base wall 221 towards the center of the base wall 221 and away from the electric connection portion 21. The positioning holes 2212 correspond to the positioning pillars 212 respectively, and the positioning holes 2212 are provided for passing and securing the positioning pillars 212 by screws 25 to combine the heat dissipating casing 22 and the electric connection portion 21. The surrounding wall 222 is extended outwardly from the periphery of the base wall 221 and includes a plurality of heat dissipating ribs 2221.

The printed circuit board 23 includes a plurality of holes 231, a center hole 232 and a groove 233. The center hole 232 and the groove 233 are provided for providing the flexibility of the printed circuit board 23, such that the printed circuit board 23 can be passed through and secured to the holes 231 by the screws 25, and the printed circuit board 23 is attached closely onto the arc camber 2211 of the base wall 221 along the base wall 221, such that the printed circuit board 23 has a curvature corresponding to the arc camber 221.

The light emitting diodes 24 are installed with an interval apart from each other and on the printed circuit board 2, and corresponding to the curvature of the arc camber 2211.

The transparent cover 26 can be made of plastic or glass, and covered onto a side of the heat dissipating casing 22, for sealing the printed circuit board 23 and the light emitting diodes 24.

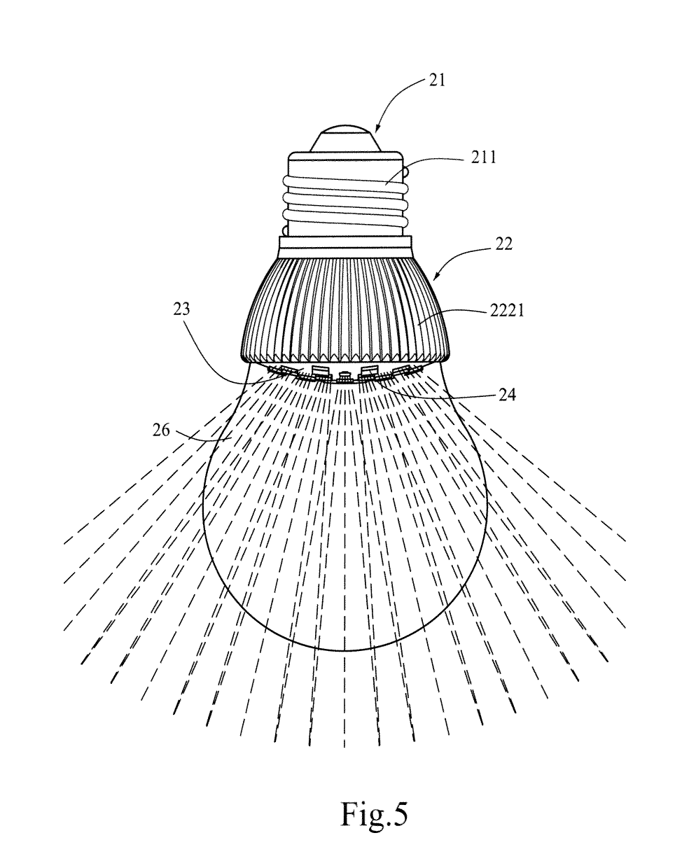

With reference to FIG. 5 for a schematic view of a light path of an illumination lamp in accordance with a preferred embodiment of the present invention, the light emitting diodes 24 correspond to the arc camber 2211, so that the lights produced by the light emitting diodes 24 installed at the external periphery of the base wall 221 can be projected with a wider angle to expand the illumination range, and prevent the lights from concentrating at a specific area to improve the illumination uniformity.

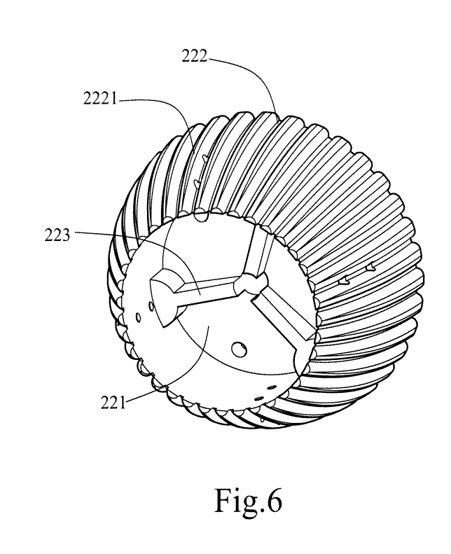

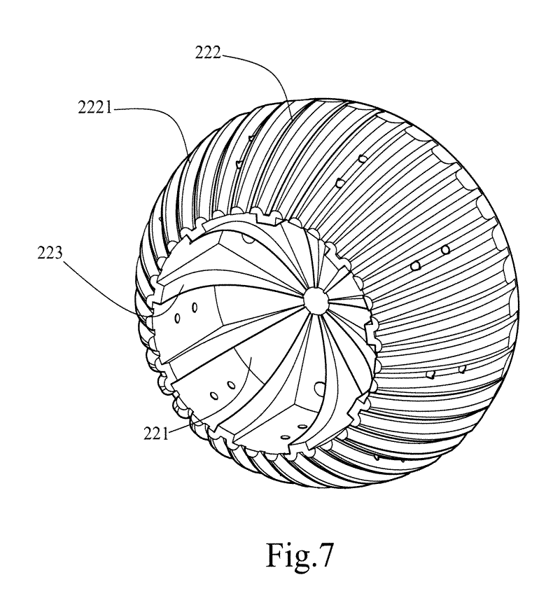

To improve the thermal conducting efficiency and lower the temperature of the light emitting diodes 24, the base wall 221 further includes a plurality of thermal conductors 223 installed on another side of the printed circuit board 23, and the thermal conductors 223 can be extended radially from a center hole of the base wall 221 to the external periphery of the base wall 221, or extended radially from the center hole of the base wall 221 to the top of the surrounding wall 222 as shown in FIGS. 6 and 7 respectively.

In summation of the description above, the illumination lamp of the present invention can expand the illumination range and improve the illumination uniformity by adjusting the angle of the light emitting diodes to distribute the light emitting diodes on an arc camber, so as to provide a suitable application for indoor illumination. Obviously, the present invention can improve over the prior art and comply with the patent application requirements, and thus the invention is duly filed for patent application. While the invention has been described by device of specific embodiments, numerous modifications and variations could be made thereto by those generally skilled in the art without departing from the scope and spirit of the invention set forth in the claims.

What is claimed is:

1. An illumination lamp, comprising:
an electric connection portion;
a heat dissipating casing, installed on a side of the electric connection portion, and comprising:
a base wall, having an arc camber, protruded from the periphery of the base wall in a direction towards the center of the base wall and away from the electric connection portion; and
a surrounding wall, extended outwardly from the periphery of the base wall;
a printed circuit board, having a center hole and a groove, and attached onto a side of the base wall;
a plurality of light emitting diodes, installed on the printed circuit board and with an interval apart from each other; and
a transparent cover, covered onto a side of the heat dissipating casing.

2. The illumination lamp of claim 1, wherein the surrounding wall includes a plurality of heat dissipating ribs.

3. The illumination lamp of claim 1, wherein the electric connection portion further includes a plurality of positioning pillars, and the base wall further includes a plurality of positioning holes, and the positioning pillars correspond to the positioning holes respectively.

4. The illumination lamp of claim 1, wherein the heat dissipating casing is made of aluminum or aluminum alloy.

5. The illumination lamp of claim 1, wherein the base wall further has a center hole, and another side of the base wall has a plurality of thermal conductors, and the thermal conductors are extended radially outward from the center hole.
